(19) United States
(12) Patent Application Publication
(10) Pub. No.: US 2022/0051115 A1
(43) Pub. Date: Feb. 17, 2022

(54) Control Platform Using Machine Learning for Remote Mobile Device Wake Up

(71) Applicant: Allstate Insurance Company, Northbrook, IL (US)

(72) Inventors: Benjamin Robertson Yeomans, Greensboro, NC (US); Shanshan Wang, Northbrook, IL (US); Ryan Walton, Northbrook, IL (US); Andrew L. Carbery, Bartlett, IL (US)

(73) Assignee: Allstate Insurance Company, Northbrook, IL (US)

(21) Appl. No.: 16/991,154

(22) Filed: Aug. 12, 2020

(51) Int. Cl. G06N 5/04; G06N 20/00

(52) U.S. Cl. CPC G06N 5/04; G06N 20/00

(57) ABSTRACT

Aspects of the disclosure relate to using machine learning for remote wake up of a mobile device. A computing platform may receive historical data corresponding to driving trip patterns. The computing platform may train a machine learning model using the historical data corresponding to the driving trip patterns. The computing platform may receive initial data corresponding to a particular individual, and input the initial data into the machine learning model, which may cause output of a predicted trip start time of a driving trip of the particular individual. The computing platform may send, to a mobile device corresponding to the particular individual, one or more commands directing the mobile device to wake up prior to the predicted trip start time and to initiate collection of driving trip data corresponding to the driving trip, which may cause the mobile device to be configured for the collection of driving trip data.

### BACKGROUND

Aspects of the disclosure relate to processing systems. In particular, aspects of the disclosure relate to processing systems having a machine learning engine and machine learning datasets.

One method of evaluating a risk level corresponding to a driver is to generate a personalized driving score based on his or her driving trip data. In some instances, this driving trip data may be collected by one or more sensors in the driver's mobile device. To accurately compute the driving score, it may be important to collect sensor data from the moment a trip starts until the moment it ends. In some instances, however, there may be a delay in waking the mobile device up due to the limited information available to the mobile device while it is asleep, which may result in the mobile device being unable to collect driving data until after the trip starts. This may result in inaccurate or sub-optimal computation of driving scores.

### SUMMARY

Aspects of the disclosure provide effective, efficient, scalable, and convenient technical solutions that address and overcome the technical problems associated with using mobile devices for collection of driving trip data.

In accordance with one or more embodiments, a computing platform comprising at least one processor, a communication interface communicatively coupled to the at least one processor, and memory may receive historical data corresponding to driving trip patterns. The computing platform may train a machine learning model using the historical data corresponding to the driving trip patterns. The computing platform may receive initial data corresponding to a particular individual. The computing platform may input the initial data corresponding to the particular individual into the machine learning model, which may cause output of a predicted trip start time of a driving trip of the particular individual. The computing platform may send, to a mobile device corresponding to the particular individual, one or more commands directing the mobile device to wake up prior to the predicted trip start time and to initiate collection of driving trip data corresponding to the driving trip, which may cause the mobile device to be configured for the collection of driving trip data.

In one or more embodiments, the computing platform may receive the historical data by receiving one or more of: global positioning system (GPS) data, time information, demographics information, income information, accelerometer data, gyroscope data, barometer data, magnetometer data, or social media data. In one or more embodiments, the computing platform may train the machine learning model by validating a first subset of the historical data received from the mobile device with a second subset of the historical data received from an on board diagnostics (OBD) system or mobile device.

In one or more embodiments, the historical trip data may be labelled with a corresponding trip start time. In one or more embodiments, the labeled trip start time of the driving trip of the particular individual may be identified by: 1) identifying a match between the initial data (which may e.g., be data from a mobile device) and at least a portion of the historical data (which may e.g., be data from an OBD II device); 2) identifying a historical driving trip corresponding to the portion of the historical data; and 3) identifying a start time of the historical driving trip (which may, e.g., be the predicted trip start time).

In one or more embodiments, the mobile device might not be configured to collect driving trip data prior to waking up. In one or more embodiments, the computing platform may receive the driving trip data from the mobile device. The computing platform may input the driving trip data into the machine learning model, which may cause output of a predicted trip end time of a driving trip of the particular individual. The computing platform may send, to the mobile device, one or more commands directing the mobile device to stop collection of the driving trip data at the predicted trip end time, which may cause the mobile device to stop collection of the driving trip data at the predicted trip end time. In one or more embodiments, the computing platform may dynamically update the machine learning model based on the driving trip data.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for applying machine learning for remote mobile device wake up in accordance with one or more example embodiments;

FIGS. 2A-2D depict an illustrative event sequence for applying machine learning for remote mobile device wake up in accordance with one or more example embodiments;

FIGS. 3 and 4 depict example graphical user interfaces for applying machine learning for remote mobile device wake up in accordance with one or more example embodiments; and

FIG. 5 depicts an illustrative method for applying machine learning for remote mobile device wake up in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further below, the disclosure herein describes systems and methods that implement machine learning techniques to send remote wake up commands to a mobile device, which may cause the mobile device to wake up (e.g., transition from an inactive state where, for instance, one or more applications, functions, or the like are disabled or inactive, to an active state where, for instance, one or more applications are initiated, activated, enabled, or the like) in response. For example, it may be important to measure and record sensor data from a driver's mobile device from the moment a trip starts until the trip has ended. In some instances, however, there may be a delay in waking the mobile device up (and therefore starting a trip) due to limited information available while the mobile device is asleep (e.g., in an inactive state).

One or more of the systems and methods described herein address this trip start delay problem by waking the phone up via an alert that is sent from a server. This alert may be generated and sent using a machine learning model that looks at historical trip data and predicts when the trip will actually start. Once the mobile device is awake, it may have all the sensor data available to it and may have one or more applications or functions initiated and ready, and may therefore be more likely to start a trip on time.

In doing so, numerous technical advantages may be realized. For example, the mobile device may be awake at the correct trip start time more often, and accordingly may be configured to capture more miles travelled, event experiences, collisions, or the like, which may improve perception and reality of trip accuracy and/or driving score computations. Furthermore, by allowing the mobile device to remain asleep until just before the predicted trip start time, the methods described herein may have minimal impacts on a battery of the mobile device. For example, rather than merely leaving the mobile device in awake mode all day (which would presumably allow for the capture of driving data at the predicted start time), which would significantly drain the battery of a mobile device, the mobile device may remain in an asleep mode (that conserves battery), until just before a predicted start time. Furthermore, the methods described herein may be performed or otherwise implemented without modifying the size of a software development kit (SDK) for the mobile device.

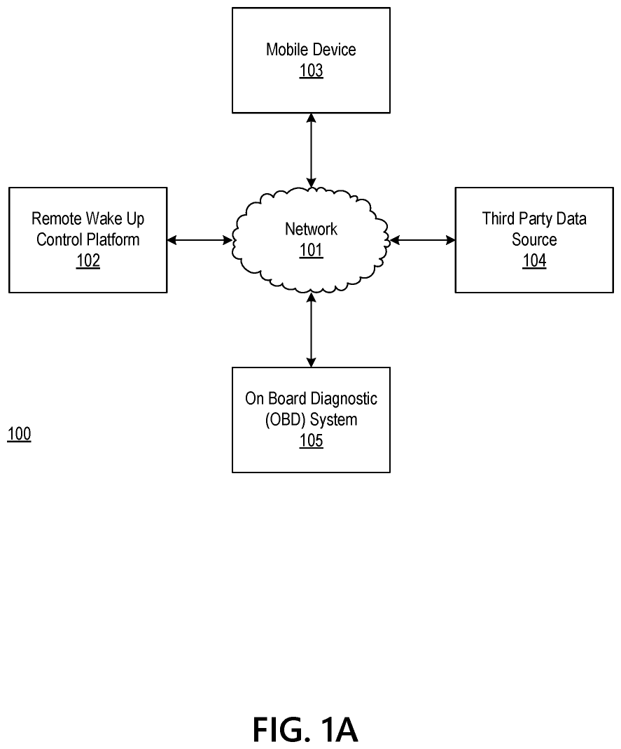

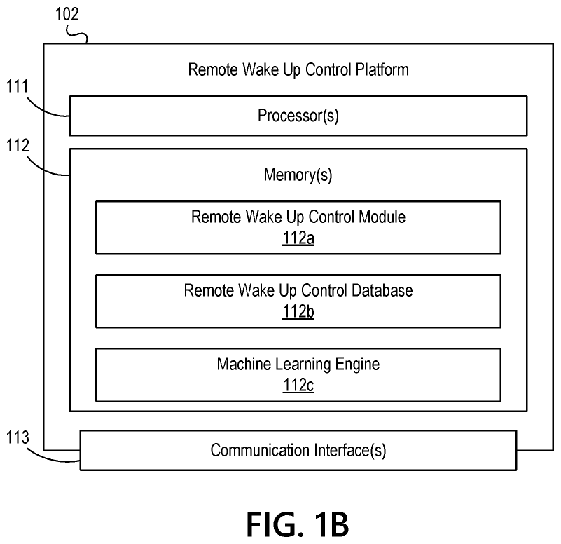

FIGS. 1A and 1B depict an illustrative computing environment for applying machine learning for remote mobile device wake up in accordance with one or more example embodiments. Referring to FIG. 1A, computing environment 100 may include one or more computer systems. For example, computing environment 100 may include a remote wake up control platform 102, mobile device 103, third party data source 104, and an on-board diagnostic (OBD) system 105.

As illustrated in greater detail below, remote wake up control platform 102 may include one or more computing devices configured to perform one or more of the functions described herein. For example, remote wake up control platform 102 may include one or more computers (e.g., laptop computers, desktop computers, servers, server blades, or the like) and/or other computer components (e.g., processors, memories, communication interfaces). In addition, and as illustrated in greater detail below, remote wake up control platform 102 may be configured apply one or more machine learning techniques to identify a predicted trip start time based on historical data. In some instances, the remote wake up control platform 102 may be further configured to generate one or more commands that may cause the mobile device 103 to wake up and be configured for data collection.

Mobile device 103 may be a mobile computing device (e.g., smartphone, tablet, or the like) that may be linked to and/or used by a first user (who may, e.g., be a driver of a vehicle). In some instances, mobile device 103 may be configured with one or more sensors that may be used to collect data corresponding to a driving trip (e.g., telematics data, global positioning systems (GPS) data, time information, or the like). In some instances, the network 101 may include one or more mobile devices (e.g., each corresponding to a different individual, or the like). In some instances, the mobile device 103 may be configured to enable an awake state (e.g., screen activated, processors activated, or the like) and/or an asleep state (e.g., no display, processors disengaged, or the like). For example, the mobile device 103 may be configured to switch between the awake state (which may enable processing by the mobile device 103) and the asleep state (which may conserve battery).

Third party data source 104 may include one or more computers (e.g., laptop computers, desktop computers, servers, server blades, or the like) and/or other computer components (e.g., processors, memories, communication interfaces). In some instances, third party data source 104 may be configured to store and provide data such as geospatial data, social media data, demographics data, or the like. In some instances, the network 101 may include one or more third party data sources that each provide different types of third party data.

OBD system 105 may be one or more computers and may include one or more other computer components (e.g., sensors, processors, memories, communication interfaces, or the like), and may, in some instances, be integrated into or otherwise located in a vehicle. In some instances, the OBD system 105 may be configured to collect data corresponding to a driving trip (e.g., telematics data, GPS data, time information, acceleration data, gyroscope data, barometric data, magnetic data, or the like). In some instances, the OBD system 105 may collect different data than the mobile device 103, and the data collected by the OBD system 105 may be used to supplement the data from the mobile device 103. Additionally or alternatively, the OBD system 105 may collect some of the same types of data as the mobile device 103. In these instances, the data from the OBD system 105 may be used to confirm or otherwise validate data collected by the mobile device 103. In some instances, the network 101 may include multiple OBD systems (e.g., each affiliated with different drivers, vehicles, or the like).

Computing environment 100 also may include one or more networks, which may interconnect one or more of remote wake up control platform 102, mobile device 103, third party data source 104, OBD system 105, and/or one or more other systems, public networks, sub-networks, and/or the like. For example, computing environment 100 may include a network 101.

In one or more arrangements, remote wake up control platform 102, mobile device 103, third party data source 104, OBD system 105, and/or the other systems included in computing environment 100 may be any type of computing device capable of receiving a user interface, receiving input via the user interface, and/or communicating the received input to one or more other computing devices. For example, the systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of remote wake up control platform 102, mobile device 103, third party data source 104, and OBD system 105 may, in some instances, be special-purpose computing devices configured to perform specific functions.

Referring to FIG. 1B, remote wake up control platform 102 may include one or more processors 111, memory 112, and communication interface 113. A data bus may interconnect processor 111, memory 112, and communication interface 113. Communication interface 113 may be a network interface configured to support communication between remote wake up control platform 102 and one or more networks (e.g., network 101, or the like). Memory 112 may include one or more program modules having instructions that when executed by processor 111 cause remote wake up control platform 102 to perform one or more functions described herein and/or one or more databases that may store and/or otherwise maintain information which may be used by such program modules and/or processor 111. In some instances, the one or more program modules and/or databases may be stored by and/or maintained in different memory units of remote wake up control platform 102 and/or by different computing devices that may form and/or otherwise make up remote wake up control platform 102. For example, memory 112 may have, store, and/or include a remote wake up control module 112a, a remote wake up control database 112b, and a machine learning engine 112c. Remote wake up control module 112a may have instructions that direct and/or cause remote wake up control platform 102 to identify trip start times and send remote wake up commands accordingly, as discussed in greater detail below. Remote wake up control database 112b may store information used by remote wake up control module 112a and/or remote wake up control platform 102 in identifying trip start times, sending remote wake up commands, and/or in performing other functions. Machine learning engine 112c may have instructions that direct and/or cause the remote wake up control platform 102 to identify trip start times, send remote wake up commands, and to set, define, and/or iteratively refine optimization rules techniques and/or other parameters used by the remote wake up control platform 102 and/or other systems in computing environment 100.

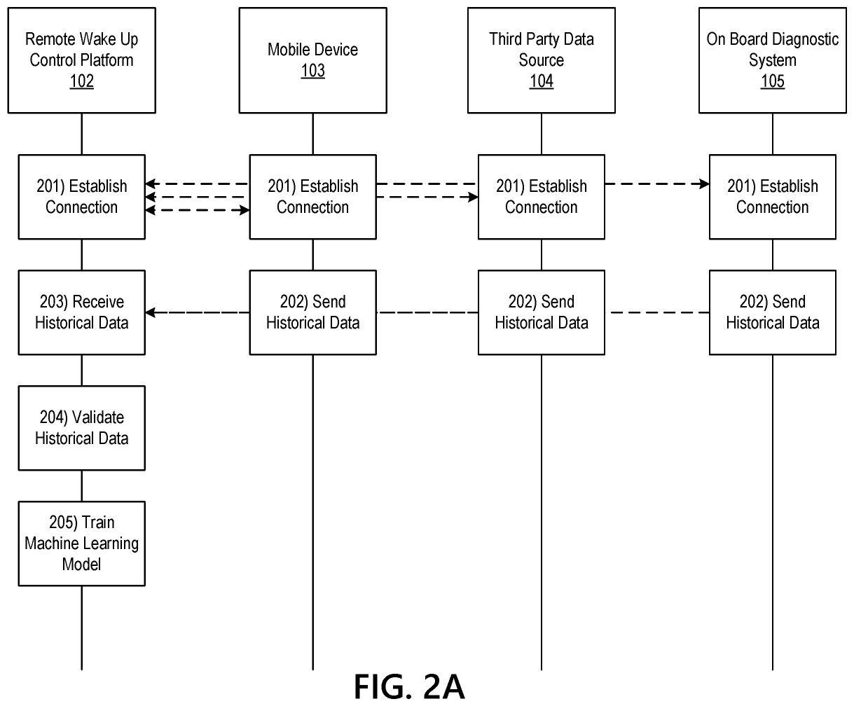

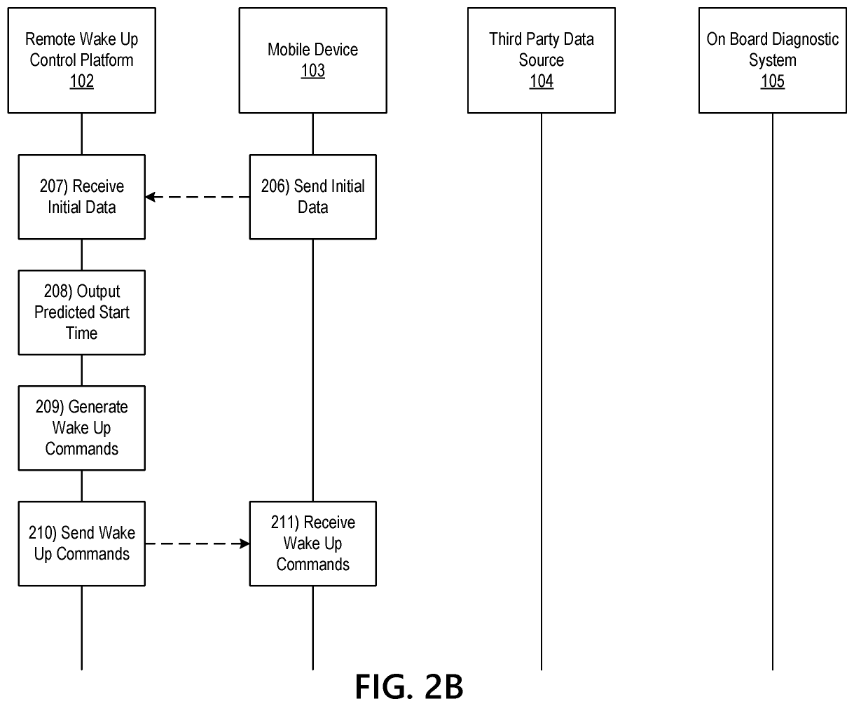

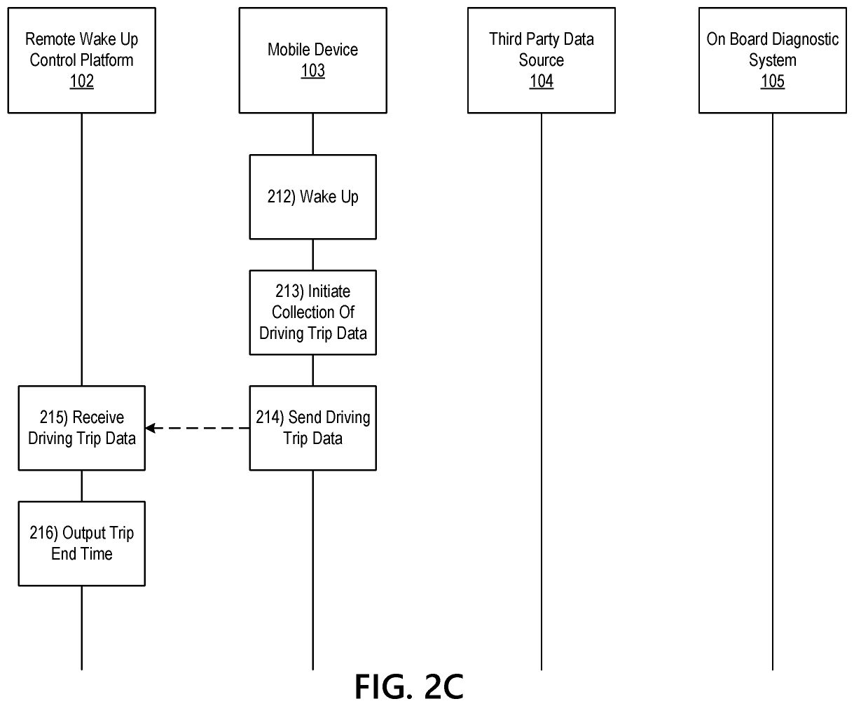

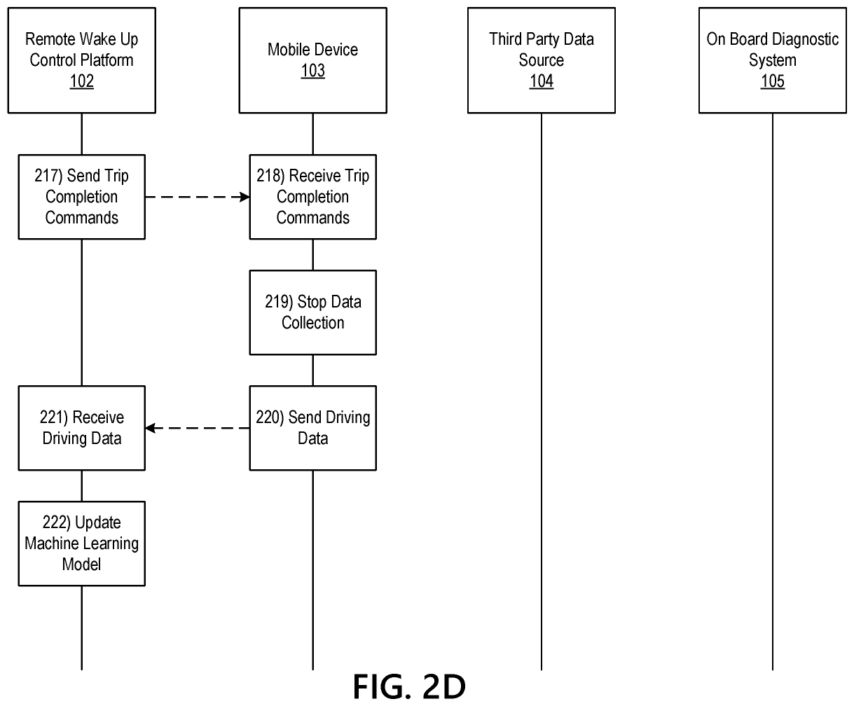

FIGS. 2A-2D depict an illustrative event sequence for applying machine learning for remote mobile device wake up in accordance with one or more example embodiments. Referring to FIG. 2A, at step 201, remote wake up control platform 102 may establish one or more wireless data connections. For example, the remote wake up control platform 102 may establish a first wireless data connection with the mobile device 103 to link the remote wake up control platform 102 to the mobile device 103 (e.g., in preparation for receiving historical data from the mobile device 103). Additionally or alternatively, the remote wake up control platform 102 may establish a second wireless data connection with the third party data source 104 (e.g. in preparation for receiving historical data from the mobile device 103). Additionally or alternatively, the remote wake up control platform 102 may establish a third wireless data connection with the OBD system 105 (e.g., in preparation for receiving historical data from the OBD system 105). In some instances, the remote wake up control platform 102 may identify whether or not the above described wireless data connections are already established. If one or more of the wireless data connections are already established, the remote wake up control platform 102 might not re-establish that connection. If one or more of the wireless data connections are not already established, the remote wake up control platform 102 may establish those connections as described herein.

At step 202, the mobile device 103, third party data source 104, and/or OBD system 105 may send historical data to the remote wake up control platform 102. For example, the mobile device 103, third party data source 104, and/or OBD system 105 may send the historical data to the remote wake up control platform while the first, second, and/or third wireless data connections are respectively established. In some instances, in sending the historical data, the mobile device 103 may send historical data corresponding to driving trips collected by the mobile device 103. For example, the mobile device 103 may collect and send GPS data (driving patterns, locations corresponding to driving trip initiation (e.g., home, work, a garage, parking lot, or the like), or the like), time information (timestamps corresponding to initiation of an identified driving trip, a typical start time, or the like), historical delay periods (e.g., an amount of time between exiting a house and starting a driving trip, or the like), application data (e.g., launch times for a map application, or the like), driving data (e.g., acceleration data, gyroscope data, barometric data, magnetic data, or the like), or the like. In some instances, the mobile device 103 may send historical data corresponding to a plurality of different vehicles including an indication of whether a corresponding individual was a passenger, driver, or the like. For example, the mobile device 103 may send historical data corresponding to car travel patterns, bus travel patterns, boat travel patterns, train travel patterns, bike travel patterns, motorcycle travel patterns, or the like. In some instances, the network 101 may include a plurality of mobile devices that may provide historical data for a plurality of individuals. Additionally or alternatively, in sending the historical data, the third party data source 104 may send demographics data (e.g., people in a particular neighborhood or a particular income level tend to leave home at a particular time, or the like), social media data, or the like. In some instances, the network 101 may include a plurality of third party data sources each configured to provide a different type of third party data related to one or more individuals. Additionally or alternatively, in sending the historical data, the OBD system 105 may send GPS data, time information, other telematics data, or the like. In some instances, the OBD system 105 may be a secondary source of data provided by the mobile device 103, and may be used to validate or otherwise confirm the historical data provided by the mobile device 103 (e.g., compare the GPS data or the like). Additionally or alternatively, the OBD system 105 may provide data that was not otherwise provided by the mobile device 103. In some instances, the network 101 may include a plurality of OBD systems each providing data about a different vehicle, individual, or the like.

At step 203, the remote wake up control platform 102 may receive the historical data from the mobile device 103, third party data source 104, and/or OBD system 105. For example, the remote wake up control platform 102 may receive the historical data from the mobile device 103, third party data source 104, and/or OBD system 105 via the communication interface 113 and while the first, second, and/or third wireless data connections are respectively established.

At step 204, the remote wake up control platform 102 may validate the historical data received at step 203. For example, in some instances, data received from the OBD system 105 may overlap with data received from the mobile device 103 (e.g., GPS, time information, telematics, or the like). In these instances, the data from the OBD system 105 may be used to validate the data from the mobile device 103. For example, the remote wake up control platform 102 may identify a difference between the data from the OBD system 105 and the mobile device 103, and compare the difference to a predetermined validation threshold (which may e.g., be specific to a particular data type). If the difference exceeds the predetermined validation threshold, the remote wake up control platform 102 may determine that the data from the mobile device 103 may be unreliable, and might not use that data for training of the machine learning model at step 205. If the difference does not exceed the predetermined validation threshold, the remote wake up control platform 102 may determine that the data from the mobile device 103 is likely reliable, and may be used for training of the machine learning model at step 205. In some instances, historical data related to driving trips, trip starts, or the like may be more accurate from the OBD system 105 than from the mobile device 103, as the OBD system 105 may be tied directly to a vehicle ignition, and thus may, in some instances, initiate data collection within a shorter time period of a trip start than the mobile device 103 (which may historically have initiated data collection based on detecting a significant location change and/or monitoring for a state of motion, and thus may fail to collect initial data corresponding to a driving trip until the location change or state of motion are detected).

At step 205, the remote wake up control platform 102 may input the historical data received at step 203 into a machine learning model, so as to train the machine learning model to identify a trip start time based on received data. For example, the remote wake up control platform 102 may establish one or more machine learning datasets corresponding to various trip start times, and may identify similarities between the one or more machine learning datasets and newly received data (e.g., as described further below) to identify a predicted trip start time. In some instances, the remote wake up control platform 102 may label the historical data with a trip start time corresponding to each piece of the historical data. In some instances, the one or more machine learning datasets may correspond to a single individual. In other instances, the one or more machine learning datasets may correspond to a plurality of individuals with similar characteristics (e.g., based on demographics, or the like).

Referring to FIG. 2B, at step 206, the mobile device 103 may collect and send initial data to the remote wake up control platform 102. In some instances, in sending the initial data to the remote wake up control platform 102, the mobile device 103 may send similar data to the historical data sent in step 202. However, in sending the initial data, the mobile device 103 may send near real-time data, which may be collected within a predetermined period of time of initiation of a driving trip (e.g., 1 hour, 30 minutes, 5 minutes, or the like). In some instances, the mobile device 103 may send the initial data to the remote wake up control platform 102 while the first wireless data connection is established. For example, in some instances, the mobile device 103 may be configured to collect certain types of data in an asleep mode (e.g., GPS data, time information, or the like), and may send this data to the remote wake up control platform 102 for analysis to identify when the mobile device 103 should be transitioned to an awake mode for the collection of driving trip data.

At step 207, the remote wake up control platform 102 may receive the initial data sent at step 206. For example, the remote wake up control platform 102 may receive the initial data via the communication interface 113 and while the first wireless data connection is established.

At step 208, the remote wake up control platform 102 may feed the initial data into the machine learning model that was trained at step 205, and may apply the machine learning model to output a predicted start time. For example, the remote wake up control platform 102 may identify a match between the initial data and at least a portion of the historical data stored in the machine learning model. The remote wake up control platform 102 may then identify a historical driving trip corresponding to the portion of the historical data, and a start time of the identified historical driving trip (which may e.g., correspond to the predicted start time). In some instances, the remote wake up control platform 102 may identify a match between the initial data and historical data corresponding to the individual. In other instances, the remote wake up control platform 102 may identify a match between characteristics of the individual and another individual (e.g., demographics, social media, or the like), and may then compare the initial data to historical data corresponding to that other individual to output a predicted start time. For example, employees of the same company, with the same job title, who work in the same office, may tend to leave the office and commute home at a similar time, so the predicted start times may be similar for these employees.

As a particular example, the remote wake up control platform 102 may identify an individual corresponding to the initial data (e.g., based on a device identifier, or the like), and may identify, based on the initial data, a location of the mobile device 103. Using the machine learning model, the remote wake up control platform 102 may identify that the location of the mobile device 103 corresponds to a parking lot at an office building in which the individual works, and may identify that on average, the individual initiates his or her driving trip home from work within 5 minutes after arriving in the parking lot. Accordingly, the remote wake up control platform 102 may identify that the predicted start time is 5 minutes from a current time.

At step 209, the remote wake up control platform 102 may generate one or more commands directing the mobile device 103 to wake up prior to the predicted start time output at step 208. For example, the remote wake up control platform 102 may generate one or more commands that cause the mobile device 103 to configure itself and/or otherwise enable data collection. In some instances, in generating the one or more commands directing the mobile device 103 to wake up prior to the predicted start time, the remote wake up control platform 102 may generate one or more commands directing the mobile device to initiate collection of driving data at the predicted trip start time.

At step 210, the remote wake up control platform 102 may send the one or more commands directing the mobile device 103 to wake up prior to the predicted start time and/or initiate collection of driving data at the predicted trip start time to the mobile device 103. For example, the remote wake up control platform 102 may send the one or more commands directing the mobile device 103 to wake up prior to the predicted start time to the mobile device 103 via the communication interface 113 and while the first wireless data connection is established.

At step 211, the mobile device 103 may receive the one or more commands directing the mobile device 103 to wake up prior to the predicted start time and/or initiate collection of driving data at the predicted trip start time. For example, the mobile device 103 may receive the one or more commands directing the mobile device 103 to wake up while the first wireless data connection is established.

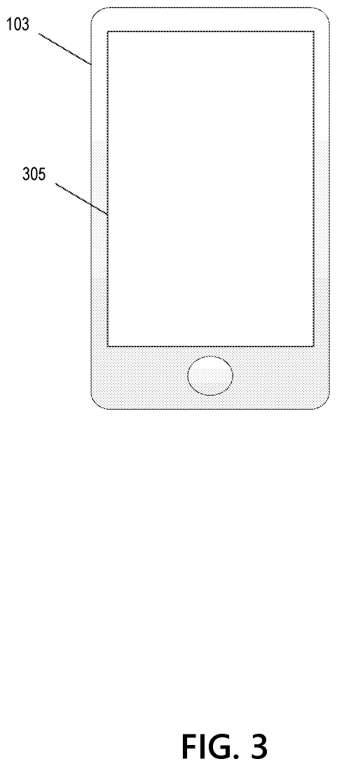

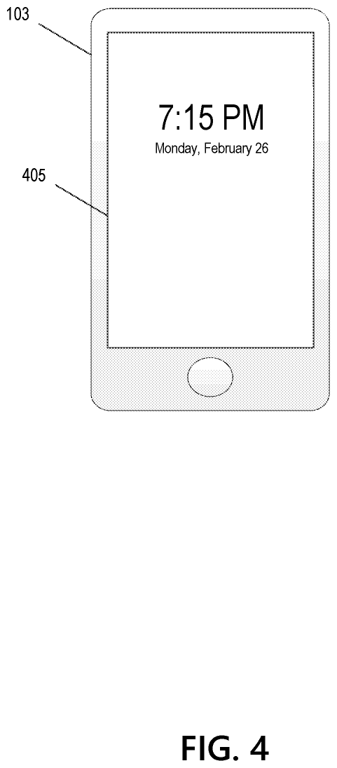

Referring to FIG. 2C, at step 212, the mobile device 103 may wake up in response to or based on the one or more commands directing the mobile device 103 to wake up prior to the predicted start time and/or initiate collection of driving data at the predicted trip start time. For example, the mobile device 103 may configure itself for or otherwise enable collection of driving data. For example, prior to step 212, the mobile device 103 might not display any graphical user interface (e.g., screen may be dark or blank), as shown in FIG. 3. For example, the screen of mobile device 103 may resemble screen 305. In contrast, once the mobile device 103 wakes up at step 212, the mobile device 103 may display a graphical user interface similar to graphical user interface 405, which is shown in FIG. 4, or other desired or predetermined graphical user interface. For example, the mobile device 103 may display a home screen, phone locked screen, or other interface indicating that the mobile device 103 is awake. In doing so, the mobile device 103 may wake up in a predictive (e.g., as predicted by the remote wake up control platform 102) manner based on historical data/patterns processed by a machine learning algorithm rather than a reactive manner (e.g., based on detecting significant location change, state of motion, or the like). This may allow the mobile device 103 to collect more driving trip data, which may include more collisions, events, GPS readings, sensor data (accelerometer, gyroscope, magnetometer, temperature, barometer, etc) miles travelled, or the like, which may be used in driving score computations.

In some instances, the mobile device 103 may store the predicted start time locally, and may configure its settings so as to wake up at the predicted start time on a regular basis (e.g., every day at 8 am, every weekday at 8 am, Saturday's at 10 am, or the like). In doing so, the mobile device 103 may configure itself for automated wake up in advance of a driving trip based on pre-established driving patterns, routines, or the like, identified by the machine learning model. In some instances, along with the predicted start time, the mobile device 103 may receive a likelihood of trip start score (which may, e.g., be generated at the remote wake up control platform 102 using the machine learning model). In these instances, based on the likelihood of trip start score, the mobile device 103 may modify a duration of the period during which the mobile device 103 may remain awake (e.g., prior to returning to a state in which the mobile device 103 is asleep) while waiting to collect driving data. For example, if the mobile device 103 determines that the likelihood of trip start score exceeds a first predetermined threshold, the mobile device 103 may remain awake for a first period of time and if the mobile device determines that the likelihood of trip start score does not exceed the first predetermined threshold, the mobile device 103 may remain awake for a second period of time, shorter than the first period of time (e.g., because the chance of a trip actually starting may be lower). In some instances, this duration may be determined and/or modified by the remote wake up control platform 102 using the machine learning model, and sent to the mobile device 103 along with the one or more commands directing the mobile device 103 to wake up prior to the predicted start time and/or initiate collection of driving data at the predicted trip start time, which may, in some instances, cause the mobile device 103 to remain awake for the specified duration before returning to sleep if driving data collection does not initiate.

At step 213, the mobile device 103 may initiate collection of driving trip data. For example, in response to or based on the one or more commands directing the mobile device 103 to wake up prior to the predicted start time and/or initiate collection of driving data at the predicted trip start time, the mobile device 103 may initiate collection of driving trip data (e.g., GPS, telematics, time information, or the like) once a current time matches the predicted trip start time. For example, the mobile device 103 might not wait to detect a significant location change or change in state of motion to wake up and to initiate collection of driving trip data.

At step 214, the mobile device 103 may send the driving trip data collected at step 213. In some instances, the mobile device 103 may send the driving trip data as it is collected (e.g., streaming in in near real time). In other instances, the mobile device 103 may send the driving trip data in batches (e.g., predetermined file size, number of data points, or the like). In some instances, the mobile device 103 may send the driving trip data to the remote wake up control platform 102 while the first wireless data connection is established.

At step 215, the remote wake up control platform 102 may receive the driving trip data sent at step 214. For example, the remote wake up control platform 102 may receive the driving trip data via the communication interface 113 and while the first wireless data connection is established.

At step 216, the remote wake up control platform 102 may feed the driving trip data into the machine learning model to identify and output a trip end time. For example, the remote wake up control platform 102 may identify similar historical driving trips using the machine learning model, and may identify durations of those driving trips (e.g., typical commute time, or the like). Additionally or alternatively, the remote wake up control platform 102 may identify that a location of the mobile device 103 matches a location of the driver's home, and that the mobile device 103 has not been moving for a period of time that exceeds a predetermined threshold. Additionally or alternatively, the remote wake up control platform 102 may receive information from OBD system 105, and may use this information to identify and output the trip end time. Based on these identified durations, the remote wake up control platform 102 may identify a predicted trip end time.

In some instances, the remote wake up control platform 102 may be configured to distinguish between trip types (e.g., driver in a car, passenger in a car, boat, bus, train, plan, bike, or the like) using the machine learning model. In these instances, if the remote wake up control platform 102 identifies that the data being collected corresponds to a trip of a type other than driving a vehicle, the remote wake up control platform 102 may send one or more commands directing the mobile device 103 to stop data collection, and may update the machine learning model to improve the output of future trip start times (e.g., an individual rides his or her bike to work on Fridays, so a trip start time should not be predicted and/or data collection should not be initiated for that morning or afternoon).

Referring to FIG. 2D, at step 217, the remote wake up control platform 102 may generate and send one or more commands directing the mobile device 103 to stop data collection. In some instances, the remote wake up control platform 102 may send the one or more commands directing the mobile device 103 to stop data collection via the communication interface 113 and while the first wireless data connection is established.

At step 218, the mobile device 103 may receive the one or more commands directing the mobile device 103 to stop data collection. For example, the mobile device 103 may receive the one or more commands directing the mobile device 103 to stop data collection while the first wireless data connection is established.

At step 219, the mobile device 103 may stop collection of driving data. For example, the mobile device 103 may stop collection of the driving data based on or in response to the one or more commands directing the mobile device 103 to stop data collection.

At step 220, the mobile device 103 may send any remaining driving data that has not yet been sent to the remote wake up control platform 102. For example, the mobile device 103 may send the remaining driving data to the remote wake up control platform 102 while the first wireless data connection is established.

At step 221, the remote wake up control platform 102 may receive the driving data sent at step 220. For example, the remote wake up control platform 102 may receive the driving data via the communication interface 113 and while the first wireless data connection is established.

At step 222, the remote wake up control platform 102 may update the machine learning model based on the received driving data, the predicted trip start time, and the predicted trip end time. For example, the remote wake up control platform 102 may iteratively refine the machine learning model based on additional data. In some instances, the mobile device 103 may display or otherwise present a prompt requesting validation of the predicted trip start time and/or predicted trip end time, and may send user feedback to the remote wake up control platform 102 accordingly (e.g., which the remote wake up control platform 102 may use to update the machine learning model).

In some instances, in the process of updating the machine learning model, the remote wake up control platform 102 may use the received driving data to predict a start location for the recorded driving trip, and may update the machine learning model accordingly. For example, the remote wake up control platform 102 may identify that the mobile device 103 was in a first location (e.g., the driver's home, office, an end location of a previous driving trip, or the like), and that the detected trip start location was a mile from the first location. In this example, the remote wake up control platform 102 may determine that the mobile device 103 waited too long to wake up (e.g., the trip started before the mobile device 103 woke up), and may update the machine learning model to improve data collection for future trips.

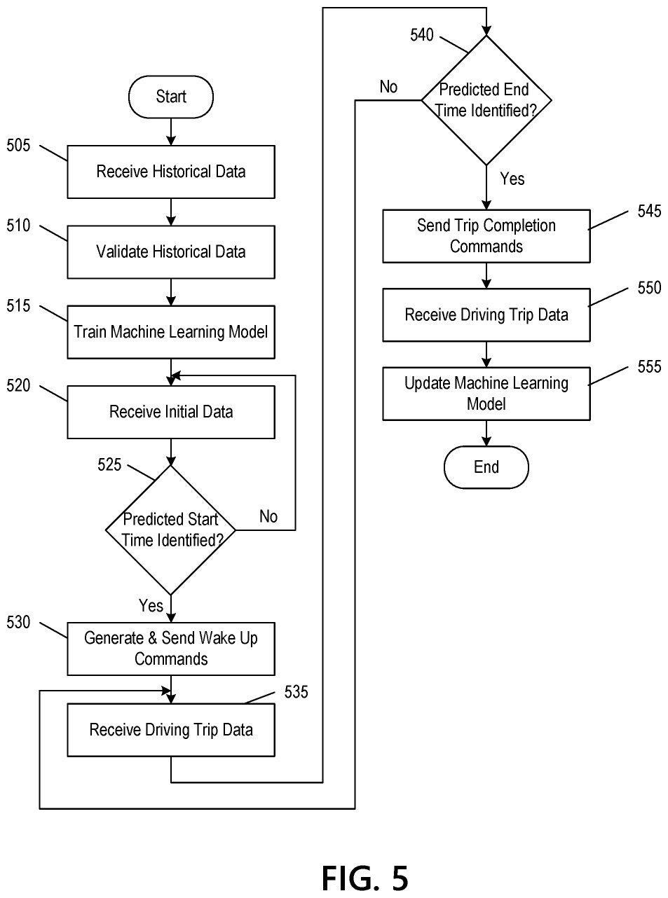

FIG. 5 depicts an illustrative method for applying machine learning for remote mobile device wake up in accordance with one or more example embodiments. Referring to FIG. 5, at step 505, a computing platform having at least one processor, a communication interface, and a memory may receive historical data related to one or more individuals. At step 510, the computing platform may validate the historical data. At step 515, the computing platform may use the historical data to train a machine learning model. At step 520, the computing platform may receive initial data related to a particular individual. At step 525, the computing platform may determine whether or not a predicted start time was identified using the machine learning model and the initial data. If a predicted start time was not identified, the computing platform may return to step 520. If a predicted start time was identified, the computing platform may proceed to step 530.

At step 530, the computing platform may generate and send one or more commands directing a mobile device to wake up. At step 535, the computing platform may receive driving trip data. At step 540, the computing platform may determine whether a predicted end time was identified using machine learning and the driving trip data. If a predicted end time was not identified, the computing platform may return to step 535. If a predicted end time was identified, the computing platform may proceed to step 545.

At step 545, the computing platform may send one or more commands directing the mobile device to stop collecting driving trip data. At step 550, the computing platform may receive remaining driving trip data. At step 555, the computing platform may update the machine learning model based on the driving trip data.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive historical data corresponding to driving trip patterns;
train a machine learning model using the historical data corresponding to the driving trip patterns;
receive initial data corresponding to a particular individual;
input the initial data corresponding to the particular individual into the machine learning model, wherein inputting the initial data corresponding to the particular individual into the machine learning model causes output of a predicted trip start time of a driving trip of the particular individual; and
send, to a mobile device corresponding to the particular individual, one or more commands directing the mobile device to wake up prior to the predicted trip start time and to initiate collection of driving trip data corresponding to the driving trip, wherein directing the mobile device to wake up causes the mobile device to be configured for the collection of driving trip data.

2. The computing platform of claim 1, wherein receiving the historical data comprises receiving one or more of: global positioning system (GPS) data, time information, demographics information, income information, accelerometer data, gyroscope data, barometer data, magnetometer data, or social media data.

3. The computing platform of claim 1, wherein training the machine learning model further comprises validating a first subset of the historical data received from the mobile device with a second subset of the historical data received from an on board diagnostics (OBD) system.

4. The computing platform of claim 1, wherein the historical data is labelled based on a corresponding historical driving trips.

5. The computing platform of claim 1, wherein the predicted trip start time of the driving trip of the particular individual is identified by:
identifying a match between the initial data and at least a portion of the historical data;
identifying a historical driving trip corresponding to the portion of the historical data; and
identifying a start time of the historical driving trip, wherein the start time of the historical driving trip corresponds to the predicted trip start time.

6. The computing platform of claim 1, wherein the mobile device is not configured to collect driving trip data prior to waking up.

7. The computing platform of claim 1, wherein the memory stores additional computer-readable instructions that, when executed by the at least one processor, further cause the computing platform to:
receive the driving trip data from the mobile device;
input the driving trip data into the machine learning model, wherein inputting the driving trip data into the machine learning model causes output of a predicted trip end time of a driving trip of the particular individual; and
send, to the mobile device, one or more commands directing the mobile device to stop collection of the driving trip data at the predicted trip end time, wherein sending the one or more commands directing the mobile device to stop collection of the driving trip data causes the mobile device to stop collection of the driving trip data at the predicted trip end time.

8. The computing platform of claim 7, wherein the memory stores additional computer-readable instructions that, when executed by the at least one processor, further cause the computing platform to:
dynamically update the machine learning model based on the driving trip data.

9. The computing platform of claim 1, wherein the historical data further corresponds to one or more of: car travel patterns, bus travel patterns, boat travel patterns, train travel patterns, bike travel patterns, or motorcycle travel patterns.

10. A method comprising:
at a computing platform comprising at least one processor, a communication interface, and memory:
receiving historical data corresponding to driving trip patterns;
training a machine learning model using the historical data corresponding to the driving trip patterns;
receiving initial data corresponding to a particular individual;
inputting the initial data corresponding to the particular individual into the machine learning model, wherein inputting the initial data corresponding to the particular individual into the machine learning model causes output of a predicted trip start time of a driving trip of the particular individual; and
sending, to a mobile device corresponding to the particular individual, one or more commands directing the mobile device to wake up prior to the predicted trip start time and to initiate collection of driving trip data corresponding to the driving trip, wherein directing the mobile device to wake up causes the mobile device to display a graphical user interface indicating that the mobile device is awake.

11. The method of claim 10, wherein receiving the historical data comprises receiving one or more of: global positioning system (GPS) data, time information, demographics information, income information, accelerometer data, gyroscope data, barometer data, magnetometer data, or social media data.

12. The method of claim 10, wherein training the machine learning model further comprises validating a first subset of the historical data received from the mobile device with a second subset of the historical data received from an on board diagnostics (OBD) system.

13. The method of claim 10, wherein the historical data is labelled based on a corresponding historical driving trip.

14. The method of claim 10, wherein the predicted trip start time of the driving trip of the particular individual is identified by:
identifying a match between the initial data and at least a portion of the historical data;
identifying a historical driving trip corresponding to the portion of the historical data; and
identifying a start time of the historical driving trip, wherein the start time of the historical driving trip corresponds to the predicted trip start time.

15. The method of claim 10, wherein the mobile device is not configured to collect driving trip data prior to waking up.

16. The method of claim 10, further comprising:
receiving the driving trip data from the mobile device;
inputting the driving trip data into the machine learning model, wherein inputting the driving trip data into the machine learning model causes output of a predicted trip end time of a driving trip of the particular individual; and
sending, to the mobile device, one or more commands directing the mobile device to stop collection of the driving trip data at the predicted trip end time, wherein sending the one or more commands directing the mobile device to stop collection of the driving trip data causes the mobile device to stop collection of the driving trip data at the predicted trip end time.

17. The method of claim 16, further comprising:
dynamically updating the machine learning model based on the driving trip data.

18. One or more non-transitory computer-readable media storing instructions that, when executed by a computing platform comprising at least one processor, a communication interface, and memory, cause the computing platform to:
receive historical data corresponding to driving trip patterns;
train a machine learning model using the historical data corresponding to the driving trip patterns;
receive initial data corresponding to a particular individual;
input the initial data corresponding to the particular individual into the machine learning model, wherein inputting the initial data corresponding to the particular individual into the machine learning model causes output of a predicted trip start time of a driving trip of the particular individual; and
send, prior to the predicted trip start time and to a mobile device corresponding to the particular individual, one or more commands directing the mobile device to wake up prior to the predicted trip start time and to initiate collection of driving trip data corresponding to the driving trip, wherein directing the mobile device to wake up causes the mobile device to wake up prior to the predicted trip start time and to be configured for the collection of driving trip data at the predicted trip start time.

19. The one or more non-transitory computer-readable media of claim 18, wherein receiving the historical data comprises receiving one or more of: global positioning system (GPS) data, time information, demographics information, income information, accelerometer data, gyroscope data, barometer data, magnetometer data, or social media data.

20. The one or more non-transitory computer-readable media of claim 18, wherein training the machine learning model further comprises validating a first subset of the historical data received from the mobile device with a second subset of the historical data received from an on board diagnostics (OBD) system.
